(19) United States
(12) Patent Application Publication
(10) Pub. No.: US 2023/0202243 A1
(43) Pub. Date: Jun. 29, 2023

(54) RADIAL VEHICLE TIRE HAVING A RUBBER RIM STRIP, USE OF A RUBBER RIM STRIP, AND A VEHICLE WHEEL SYSTEM COMPRISING THE RADIAL VEHICLE TIRE

(71) Applicant: Continental Reifen Deutschland GmbH, Hannover (DE)

(72) Inventors: Sascha Funk-Friedek, Hannover (DE); Mario Montalvo, Hannover (DE); Justus Römer, Hannover (DE); Matthias Plückers, Hannover (DE)

(73) Assignee: Continental Reifen Deutschland GmbH, Hannover (DE)

(21) Appl. No.: 17/999,973

(22) PCT Filed: May 11, 2021
(86) PCT No.: PCT/DE2021/200065

§ 371 Date: Nov. 28, 2022

(30) Foreign Application Priority Data
May 28, 2020 (DE) 10 2020 206 734.1

(51) Int. Cl. B60C 15/06

(52) U.S. Cl. CPC B60C 15/0628; B60C 2015/0682; B60C 2015/0614; B60C 2015/065

(57) ABSTRACT

The invention relates to a pneumatic vehicle tire of a radial type of construction, comprising
two bead regions with bead cores,
a carcass insert running around the bead cores and comprising carcass turn-ups extending in the direction of the sidewalls,
at least one rubber rim strip, which forms the outer surface of a bead region and consists of a first rubber rim strip part, consisting of a first rubber compound, and a second rubber rim strip part, consisting of a second rubber compound, wherein
   the first rubber rim strip part runs along the carcass turn-up and
   the second rubber rim strip part is designed such that, after pulling onto a rim, it is at least partially positioned between the bead cores and the rim,
characterized in that
   the first rubber compound has a rebound elasticity at 20° C. according to DIN 53512 in the range of 20% and 80% and the rebound elasticity of the second rubber compound, likewise measured at 20° C. according to DIN 53512, differs from the rebound elasticity of the first rubber compound.

The invention also relates to a use of a rubber rim strip and to a vehicle wheel system comprising a pneumatic vehicle tire of a radial type of construction.

The invention relates to a pneumatic vehicle tire of a radial type of construction with a rubber rim strip, comprising two bead regions with bead cores, a carcass insert running around the bead cores and comprising carcass turn-ups extending in the direction of the sidewalls.

The invention also relates to a use of a rubber rim strip and to a vehicle wheel system comprising the pneumatic vehicle tire of a radial type of construction.

Such a pneumatic vehicle tire is known from EP 2 500 188 A1. In general, a rubber rim strip in the form of a strip with a narrow cross section runs along the carcass turn-up into the region radially underneath the bead core. In this respect, the rubber rim strip can consist of one and optionally further rubber rim strip parts. In the case in which the rubber rim strip consists of two rubber rim strip parts, the first rubber rim strip part can at least partially cover the second rubber rim strip part on the outside, for example as depicted in EP 2 500 188 A1, wherein the first rubber rim strip part is overlapped by the sidewall in the direction of the tread.

One problem addressed by the invention is that of providing a pneumatic vehicle tire of a radial type of construction that solves the dichotomy between lateral stiffness and rolling resistance, and in particular has an improved rolling resistance without significantly impairing the lateral stiffness.

This problem is solved according to the invention by a pneumatic vehicle tire of a radial type of construction, comprising
two bead regions with bead cores,
a carcass insert running around the bead cores and comprising carcass turn-ups extending in the direction of the sidewalls,
at least one rubber rim strip, which forms the outer surface of a bead region and consists of a first rubber rim strip part, consisting of a first rubber compound, and a second rubber rim strip part, consisting of a second rubber compound, wherein
   the first rubber rim strip part runs along the carcass turn-up and
   the second rubber rim strip part is designed such that, after pulling onto a rim, it is at least partially positioned between the bead cores and the rim,
characterized in that
   the first rubber compound has a rebound elasticity at 20° C. according to DIN 53512 in the range of 20% and 80% and the rebound elasticity of the second rubber compound, likewise measured at 20° C. according to DIN 53512, differs from the rebound elasticity of the first rubber compound.

In EP 2500188 A1, the rolling resistance is improved by reducing the size of rubber parts (see paragraph [0023] in EP 2500188 A1). However, this has the disadvantage that it inevitably also leads to the lateral stiffness being impaired on account of the lacking rubber part. According to document EP 2500188 A1, there is therefore a dichotomy between the rolling resistance and the lateral stiffness in the production of a rubber rim strip of a pneumatic vehicle tire.

Surprisingly, in the context of the present form of the invention, it has been found that, by precisely setting the rebound elasticity of the two rubber rim strip parts of a pneumatic vehicle tire according to the invention,
the rolling resistance can be improved without decreasing the lateral stiffness of the pneumatic vehicle tire,
   or
the lateral stiffness can be improved without decreasing the rolling resistance of the pneumatic vehicle tire.

By setting the rebound elasticity of the two rubber rim strip parts of a rubber rim strip of a pneumatic vehicle tire according to the invention, it was thus possible to decouple the dichotomy described above. This constitutes a surprising technical effect.

Within the scope of the present invention, the expression “rubber compound” comprises vulcanized and unvulcanized rubber compounds, in particular vulcanized rubber compounds.

Preference is given to a device according to the invention as described above or as described as preferred above, wherein exclusively the second rubber rim strip part of each rubber rim strip forms the outer surface of the respective bead region in which the respective rubber rim strip is positioned.

An advantage of the above-described aspect of the present invention is that the lateral stiffness can be improved over pneumatic vehicle tires in which the second rubber rim strip part does not form the entire outer surface of the bead region.

Preference is given to a device according to the invention as described above or as described as preferred above, wherein the pneumatic vehicle tire has a respective rubber rim strip in each of the two bead regions of the pneumatic vehicle tire, wherein each of the two rubber rim strips forms the respective outer surface of the bead region and consists of a first rubber rim strip part, consisting of a first rubber compound, and a second rubber rim strip part, consisting of a second rubber compound, wherein
the first rubber compound of the one rubber rim strip is the same rubber compound as the first rubber compound of the other rubber rim strip,
the second rubber compound of the one rubber rim strip is the same rubber compound as the second rubber compound of the other rubber rim strip,
the first rubber rim strip part of each rubber rim strip runs along the respective carcass turn-up and
the second rubber rim strip part of each rubber rim strip is designed such that, after pulling onto a rim, the second rubber rim strip part is at least partially positioned between the respective bead core and the rim,
   wherein preferably exclusively the second rubber rim strip part of the respective rubber rim strip forms the outer surface of the bead region in which the respective rubber rim strip is positioned.

Preference is given to a device according to the invention as described above or as described as preferred above, wherein the ratio of the rebound elasticity of the first rubber compound to the rebound elasticity of the second rubber compound is in the range of 1:2 to 2:1, preferably in the range of 1.01:1 to 2:1, particularly preferably in the range of 1.1:1 to 1.5:1.

An advantage of the above-described aspect of the present invention is that the rolling resistance is still further improved according to the sequence of the regions that are described above.

Preference is given to a device according to the invention as described above or as described as preferred above, wherein the first rubber compound of the first rubber rim strip part comprises a natural rubber and/or a butadiene rubber or consists of natural rubber and butadiene rubber.

An advantage of the above-described aspect of the present invention is that the rolling resistance, in particular in the case of such rubber rim strips, is improved over rubber rim strips comprising other types of rubber.

Preference is given to a device according to the invention as described above or as described as preferred above, wherein the first and/or the second rubber compound comprises a natural rubber in amounts of 10 to 50 phr and/or a butadiene rubber in amounts of 50 to 90 phr, preferably a natural rubber in amounts of 15 to 35 phr and/or a butadiene rubber in amounts of 65 to 85 phr.

An advantage of the above-described aspect of the present invention is that the rolling resistance is still further improved according to the sequence of the regions that are described above.

Preference is given to a device according to the invention as described above or as described as preferred above, wherein the first and/or the second rubber compound comprises a filler, preferably carbon black, wherein the filler is particularly preferably present in an amount of 20 to 180 phr, more particularly preferably in an amount of 40 to 110 phr, in particular more particularly preferably in an amount of 60 to 80 phr.

An advantage of the above-described aspect of the present invention is that the lateral stiffness is still further improved according to the sequence of the above-described regions.

Preference is given to a device according to the invention as described above or as described as preferred above, wherein the first and/or the second rubber compound comprises zinc oxide and stearic acid, wherein preferably the total amount of zinc oxide and stearic acid is in the range of 1 to 30 phr, particularly preferably in an amount of 1 to 20 phr, more particularly preferably in an amount of 5 to 9 phr.

An advantage of the above-described aspect of the present invention is that the lateral stiffness is still further improved according to the sequence of the above-described regions.

Preference is given to a device according to the invention as described above or as described as preferred above, wherein the first and/or the second rubber compound comprises zinc oxide and stearic acid, wherein the total amount of zinc oxide and stearic acid in the second rubber compound is in the range of 5 to 9 phr, and the total amount of zinc oxide and stearic acid in the first rubber compound is in the range of 10 to 15 phr.

An advantage of the above-described aspect of the present invention is that, in the case of pneumatic vehicle tires according to the invention having the above-described rubber rim strip parts, the rolling resistance is improved still further over other pneumatic vehicle tires according to the invention, while the lateral stiffness is not impaired.

Preference is given to a device according to the invention as described above or as described as preferred above, wherein the first and/or the second rubber compound comprises sulfur, wherein the total amount of sulfur is preferably in the range of 1 to 10 phr, particularly preferably in an amount of 1 to 5 phr.

An advantage of the above-described aspect of the present invention is that the lateral stiffness is still further improved according to the sequence of the above-described regions.

Preference is given to a device according to the invention as described above or as described as preferred above, wherein the first and/or the second rubber compound comprises sulfur, wherein the total amount of sulfur in the second rubber compound of the second rubber rim strip part is in the range of 1 to 2.5 phr, and the total amount of sulfur in the first rubber compound of the first rubber rim strip part is in the range of 3 to 5 phr.

An advantage of the above-described aspect of the present invention is that, in the case of pneumatic vehicle tires according to the invention having the above-described rubber rim strip parts, the rolling resistance is improved still further over other pneumatic vehicle tires according to the invention, while the lateral stiffness is not impaired.

Preference is given to a device according to the invention as described above or as described as preferred above, wherein the first and/or the second rubber compound comprises further vulcanizing agents other than sulfur, wherein the total amount of the further vulcanizing agents is preferably in the range of 1 to 10 phr, particularly preferably in an amount of 3 to 6 phr.

An advantage of the above-described aspect of the present invention is that the lateral stiffness is still further improved according to the sequence of the above-described regions.

Preference is given to a device according to the invention as described above or as described as preferred above, wherein the first rubber compound of the first rubber rim strip part comprises a resin, wherein the resin is present preferably in an amount of 1 to 30 phr, particularly preferably in an amount of 5 to 15 phr, more particularly preferably in an amount of 1 to 9 phr.

An advantage of the above-described aspect of the present invention is that the lateral stiffness is still further improved according to the sequence of the above-described regions.

Preference is given to a device according to the invention as described above or as described as preferred above, wherein the first and/or the second rubber compound comprises a resin, wherein the resin is preferably present in an amount of 0 to 4 phr and particularly preferably there is no resin at all in the second rubber compound.

An advantage of the above-described aspect of the present invention is that, in the case of pneumatic vehicle tires according to the invention having the above-described rubber rim strip parts, the rolling resistance is improved still further over other pneumatic vehicle tires according to the invention, while the lateral stiffness is not impaired.

Preference is given to a device according to the invention as described above or as described as preferred above, wherein
the first rubber compound has a Shore hardness in the range of 60 Sh A to 130 Sh A, preferably a Shore hardness in the range of 60 Sh A to 80 Sh A, measured at 20° C. by means of a durometer according to DIN ISO 7619-1, wherein the ratio of the Shore hardness of the first rubber compound to the Shore hardness of the second rubber compound is preferably in the range of 1:2 to 4:1, particularly preferably in the range of 1:1.5 to 2:1, more particularly preferably in the range of 1:1.1 to 1.5:1, in particular more particularly preferably in the range of 1:1.1 to 1.1:1.

An advantage of the above-described aspect of the present invention is that the lateral stiffness is still further improved according to the sequence of the above-described regions.

Preference is given to a device according to the invention as described above or as described as preferred above, wherein the second rubber compound has a Shore hardness of greater than 30 Sh A, preferably a Shore hardness in the range of 40 Sh A to 89 Sh A, particularly preferably a Shore hardness in the range of 65 Sh A to 80 Sh A, in each case measured at 20° C. by means of a durometer according to DIN ISO 7619-1, wherein the ratio of the Shore hardness of the first rubber compound to the Shore hardness of the second rubber compound is preferably in the range of 1:2 to 4:1, particularly preferably in the range of 1:1.5 to 2:1, more particularly preferably in the range of 1:1.1 to 1.5:1, in particular more particularly preferably in the range of 1:1.1 to 1.1:1.

An advantage of the above-described aspect of the present invention is that the lateral stiffness is still further improved according to the sequence of the above-described regions.

Preference is given to a device according to the invention as described above or as described as preferred above, wherein
the first rubber compound has a Shore hardness in the range of 60 Sh A to 130 Sh A, preferably a Shore hardness in the range of 60 Sh A to 80 Sh A, measured at 20° C. by means of a durometer according to DIN ISO 7619-1, wherein the ratio of the Shore hardness of the first rubber compound to the Shore hardness of the second rubber compound is preferably in the range of 1:2 to 4:1, particularly preferably in the range of 1:1.5 to 2:1, more particularly preferably in the range of 1:1.1 to 1.5:1, in particular more particularly preferably in the range of 1:1.1 to 1.1:1,

and
the second rubber compound has a Shore hardness of greater than 30 Sh A, preferably a Shore hardness in the range of 40 Sh A to 89 Sh A, particularly preferably a Shore hardness in the range of 65 Sh A to 80 Sh A, in each case measured at 20° C. by means of a durometer according to DIN ISO 7619-1, wherein the ratio of the Shore hardness of the first rubber compound to the Shore hardness of the second rubber compound is preferably in the range of 1:2 to 4:1, particularly preferably in the range of 1:1.5 to 2:1, more particularly preferably in the range of 1:1.1 to 1.5:1, in particular more particularly preferably in the range of 1:1.1 to 1.1:1.

An advantage of the above-described aspect of the present invention is that the lateral stiffness is still further improved according to the sequence of the above-described regions.

Preference is given to a device according to the invention as described above or as described as preferred above, wherein the ratio of the Shore hardness of the first rubber compound to the Shore hardness of the second rubber compound is in the range of 1:2 to 4:1, preferably in the range of 1:1.5 to 2:1, particularly preferably in the range of 1:1.1 to 1.5:1, more particularly preferably in the range of 1:1.1 to 1.1:1.

An advantage of the above-described aspect of the present invention is that the lateral stiffness is still further improved according to the sequence of the above-described regions.

Preference is given to a device according to the invention as described above or as described as preferred above, wherein the first rubber compound has a Shore hardness in the range of 60 Sh A to 130 Sh A and the second rubber compound has a Shore hardness of greater than 30 Sh A, preferably the first rubber compound has a Shore hardness in the range of 60 Sh A to 130 Sh A and the second rubber compound has a Shore hardness in the range of 40 Sh A to 89 Sh A, more preferably the first rubber compound has a Shore hardness in the range of 60 Sh A to 80 Sh A and the second rubber compound has a Shore hardness in the range of 65 Sh A to 80 Sh A, measured at 20° C. by means of a durometer according to DIN ISO 7619-1.

An advantage of the above-described aspect of the present invention is that the lateral stiffness is still further improved according to the sequence of the above-described regions.

Preference is given to a device according to the invention as described above or as described as preferred above, wherein
the first rubber compound has a rebound elasticity of greater than 50%, preferably in the range of above 50% to 90%, particularly preferably in the range of above 65% to 80%, measured at 20° C. according to DIN 53512,

and/or
the second rubber compound has a rebound elasticity of less than 80%, preferably in the range of 20% to 64%, preferably in the range of 55% to 64%, in each case measured at 20° C. according to DIN 53512.

An advantage of the above-described aspect of the present invention is that, in the case of pneumatic vehicle tires according to the invention having the above-described rubber rim strip parts, the rolling resistance is improved still further over other pneumatic vehicle tires according to the invention, while the lateral stiffness is not impaired.

Preference is given to a device according to the invention as described above or as described as preferred above, wherein the ratio of the width of the first rubber rim strip part to the height of the first rubber rim strip part is in the range of 1:1 to 1:10, preferably in the range of 1:3 to 1:7.

An advantage of the above-described aspect of the present invention is that pneumatic vehicle tires according to the invention exhibiting the ratios described above have an even better rolling resistance and/or an even better lateral stiffness than other pneumatic vehicle tires according to the invention.

Preference is given to a device according to the invention as described above or as described as preferred above, wherein the ratio of the height of the first rubber rim strip part to the nominal height of the pneumatic vehicle tire is in the range of 1:1 to 1:10, preferably in the range of 1:3 to 1:7.

An advantage of the above-described aspect of the present invention is that pneumatic vehicle tires according to the invention exhibiting the ratios described above have an even better rolling resistance and/or an even better lateral stiffness than other pneumatic vehicle tires according to the invention.

A particularly high degree of preference is given to a pneumatic vehicle tire according to the invention as described above, comprising:
two bead regions with bead cores,
a carcass insert running around the bead cores and comprising carcass turn-ups extending in the direction of the sidewalls,
a respective rubber rim strip in each of the two bead regions of the pneumatic vehicle tire, wherein each of the two rubber rim strips forms the respective outer surface of the bead region and consists of a first rubber rim strip part, consisting of a first rubber compound, and a second rubber rim strip part, consisting of a second rubber compound, wherein
   the first rubber rim strip part of each rubber rim strip runs along the carcass turn-up and
   the second rubber rim strip part of each rubber rim strip is designed such that, after pulling onto a rim, it is at least partially positioned between the bead cores and the rim,

characterized in that
the first rubber compound has a rebound elasticity of between 20% and 80%, preferably between 65% and 80%, at 20° C. according to DIN 53512,

wherein
the first and the second rubber compound consists of natural rubber and butadiene rubber and comprises a natural rubber in amounts of 15 to 35 phr and a butadiene rubber in amounts of 65 to 85 phr,
the first rubber compound of the first rubber rim strip part comprises carbon black, wherein the carbon black is present in an amount of 50 to 110 phr,
the total amount of zinc oxide and stearic acid in the second rubber compound of the second rubber rim strip part is in the range of 5 to 9 phr and the total amount of zinc oxide and stearic acid in the first rubber compound of the first rubber rim strip part is in the range of 10 to 15 phr,
the total amount of sulfur in the second rubber compound of the second rubber rim strip part is in the range of 1 to 2.5 phr and the total amount of sulfur in the first rubber compound of the first rubber rim strip part is in the range of 3 to 5 phr,
the first rubber compound of the first rubber rim strip part optionally comprises further vulcanizing agents other than sulfur, wherein the total amount of the further vulcanizing agents is in the range of 3 to 6 phr,
there is no resin at all in the first and the second rubber compound,
the ratio of the width of the first rubber rim strip part to the height of the first rubber rim strip part is in the range of 1:1 to 1:10, and
the ratio of the height of the first rubber rim strip part to the nominal height of the pneumatic vehicle tire is in the range of 1:1 to 1:10.

A particularly high degree of preference is also given to a pneumatic vehicle tire according to the invention as described above, comprising:
two bead regions with bead cores,
a carcass insert running around the bead cores and comprising carcass turn-ups extending in the direction of the sidewalls,
a respective rubber rim strip in each of the two bead regions of the pneumatic vehicle tire, wherein each of the two rubber rim strips forms the respective outer surface of the bead region and consists of a first rubber rim strip part, consisting of a first rubber compound, and a second rubber rim strip part, consisting of a second rubber compound, wherein
   the first rubber rim strip part of each rubber rim strip runs along the carcass turn-up and
   the second rubber rim strip part of each rubber rim strip is designed such that, after pulling onto a rim, it is at least partially positioned between the bead cores and the rim,

characterized in that
the first rubber compound has a rebound elasticity in the range of above 65% to 80% at 20° C. according to DIN 53512,

wherein
the first and the second rubber compound consists of natural rubber and butadiene rubber,
the second rubber compound has a Shore hardness in the range of 65 Sh A to 80 Sh A,
the first rubber compound has a Shore hardness in the range of 60 Sh A to 80 Sh A, measured at 20° C. by means of a durometer according to DIN ISO 7619-1,
the second rubber compound of the first rubber rim strip part has a rebound elasticity in the range of 20% to 65%, measured at 20° C. according to DIN 53512,
the ratio of the width of the first rubber rim strip part to the height of the first rubber rim strip part is in the range of 1:1 to 1:10,

and
the ratio of the height of the first rubber rim strip part to the nominal height of the pneumatic vehicle tire is in the range of 1:1 to 1:10.

The above-described advantageous aspects of a pneumatic vehicle tire according to the invention of a radial type of construction also apply to all aspects of a vehicle wheel system that is described below, and the advantageous aspects of vehicle wheel systems according to the invention that are discussed below apply correspondingly to all aspects of a pneumatic vehicle tire according to the invention of a radial type of construction.

The invention also relates to a vehicle wheel system, comprising a rim and a pneumatic vehicle tire, pulled onto the rim, as described above or as described as preferred above, wherein the second rubber rim strip part of the pneumatic vehicle tire is at least partially positioned between the bead cores and the rim.

Preference is given to a vehicle wheel system according to the invention as described above or as described as preferred above, wherein the first rubber rim strip part extends in the direction of the sidewall beyond and in contact with the rim flange of the rim.

An advantage of the above-described aspect of the present invention is that the lateral stiffness can be improved over pneumatic vehicle tires in which the second rubber rim strip part does not extend in the direction of the sidewall beyond and in contact with the rim flange of the rim.

The above-described advantageous aspects of a pneumatic vehicle tire according to the invention of a radial type of construction and of a vehicle wheel system according to the invention also apply to all aspects of a use that is described below, and the advantageous aspects of uses according to the invention that are discussed below apply correspondingly to all aspects of a pneumatic vehicle tire according to the invention of a radial type of construction and of a vehicle wheel system according to the invention.

The invention also relates to a use of a rubber rim strip as defined in one of the preceding claims for producing a pneumatic vehicle tire, preferably for producing a pneumatic vehicle tire as described above or as described as preferred above, or a vehicle wheel system as described above or as described as preferred above.

### DESCRIPTION OF THE FIGURES

In the figures:

FIG. 1: shows a cross-sectional view through a bead region of a vehicle wheel system according to the invention in a first embodiment, wherein the second rubber rim strip part of the rubber rim strip forms the entire outer surface of the bead region;

FIG. 2: shows a cross-sectional view through a bead region of a vehicle wheel system according to the invention in a first embodiment, wherein the first rubber rim strip part forms the one part of the outer surface of the bead region and the second rubber rim strip part of the rubber rim strip forms the other part of the outer surface of the bead region.

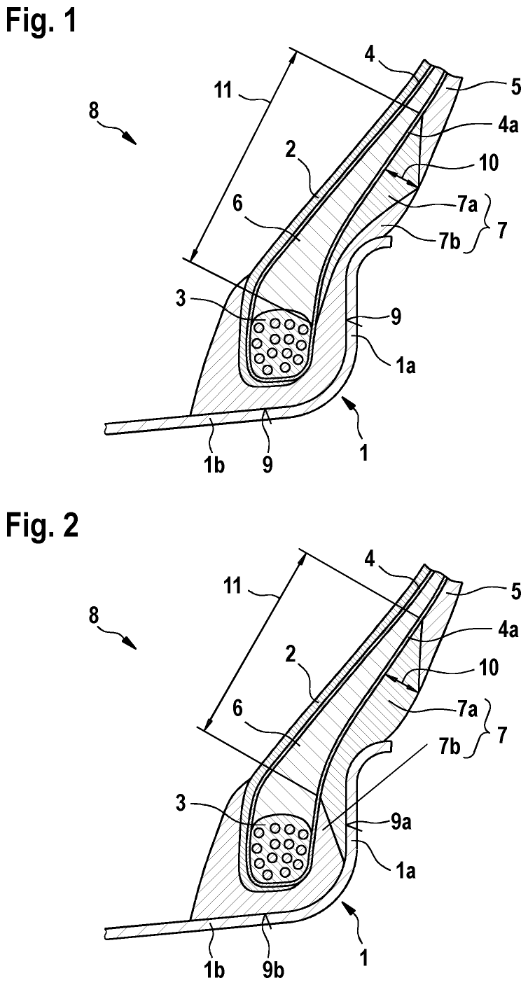

FIG. 1 shows a schematic depiction of a bead region 8 of a vehicle wheel system according to the invention in a first embodiment, comprising:
a bead core 3,
a carcass insert 4 running around the bead core 3 and comprising a carcass turn-up 4a extending in the direction of the sidewall 5,
a rubber rim strip 7 composed of a first and a second rubber rim strip part 7a, 7b, wherein the second rubber rim strip part 7b of the rubber rim strip 7 forms the entire outer surface 9 of the bead region 8 and consists of a second rubber compound and the first rubber rim strip 7a consists of a first rubber compound, wherein
the first rubber rim strip part 7a of the rubber rim strip 7 runs along the carcass turn-up 4a and
the second rubber rim strip part 7b of the rubber rim strip 7 is positioned between the bead core 3 and the rim 1,

wherein
the first rubber rim strip part 7a extends in the direction of the sidewall 5 beyond the rim flange 1a of the rim 1 and in contact with this rim flange 1a,
the ratio of the width 10 of the first rubber rim strip part 7a to the height 11 of the first rubber rim strip part 7a is in the range of 1:1 to 1:10,

and
the ratio of the height 11 of the first rubber rim strip part 7a to the nominal height of the pneumatic vehicle tire is in the range of 1:1 to 1:10.

FIG. 1 moreover shows the core profile 6 and the inner layer 2 of the pneumatic vehicle tire according to the invention and also the other part of the rim 1, the rim portion 1b.

FIG. 2 shows a schematic depiction of a bead region 8 of a vehicle wheel system according to the invention in a further embodiment, comprising:
a bead core 3,
a carcass insert 4 running around the bead core 3 and comprising a carcass turn-up 4a extending in the direction of the sidewall 5,
a rubber rim strip 7 composed of a first and a second rubber rim strip part 7a, 7b, wherein
   the first rubber rim strip part 7a consists of a first rubber compound and forms the one part 9a of the outer surface 9 of the bead region 8 and
   the second rubber rim strip part 7b of the rubber rim strip 7 forms the other part 9b of the outer surface 9 of the bead region 8 and consists of a second rubber compound,

wherein
the first rubber rim strip part 7a of the rubber rim strip 7 runs along the carcass turn-up 4a and
the second rubber rim strip part 7b of the rubber rim strip 7 is positioned between the bead core 3 and the rim 1.

FIG. 2 moreover shows the core profile 6 and the inner layer 2 of the pneumatic vehicle tire according to the invention and also the other part of the rim 1, the rim portion 1b.

### Experimental Examples

Test Methods:

1. Shore A Hardness
The results were ascertained at 20° C. by means of a durometer according to DIN ISO 7619-1.

2. Rebound Elasticity
The results were ascertained at 20° C. on the basis of the DIN 53512 method.

3. Rolling Resistance
The results were ascertained on the basis of the ISO 28580 method.

4. Lateral Stiffness Cy
The results were ascertained on the basis of the method as in paragraph [0028] of the patent document DE 102013004596 B4.

### Production:

### Production of a Rubber Compound for a Tire According to the Invention:

The production of the rubber compound according to the invention is carried out conventionally, wherein first of all as a rule a base compound containing all the constituents with the exception of the vulcanization system (sulfur and vulcanization-influencing substances) is produced in one or more mixing stages and then the finished compound is produced by adding the vulcanization system. The compound is then subjected to further processing.

The compound was produced under standard conditions in multiple stages in a laboratory tangential mixer. Test specimens were produced from all the compounds by vulcanization for 20 minutes under pressure at 160° C.

### Production of a Tire According to the Invention:

The rubber compounds as specified above were then added to a standard tire with the product name CEC6 in a conventional and known way. The tire thus obtained then had its rolling resistance and its lateral stiffness examined according to the respectively specified test methods.

### Results:

TABLE 1
Experimental data of the rubber compounds used for use in
rubber rim strips of the inventive and the non-inventive pneumatic
vehicle tire according to the following table 2

| Rubber compounds | Name: | E1 | E2 | E3 |
|---|---|---|---|---|
| Constituents | Unit | | | |
| Natural rubber | phr | 25 | 25 | 25 |
| Butadiene rubber | phr | 75 | 75 | 75 |
| Carbon black | phr | 65 | 55 | 70 |
| Aging stabilizers and | phr | 10 | 10 | 10 |
| processing aids | | | | |
| Resin | phr | 0 | 0 | 10 |
| Zinc oxide and stearic | phr | 6 | 6 | 10 |
| acid | | | | |
| Vulcanization | phr | 4 | 4 | 4 |
| accelerator | | | | |
| Sulfur | phr | 1 | 3.5 | 3.5 |
| Compound properties | | | | |
| Shore A hardness | Sh A | 73 | 73 | 90 |
| Rebound elasticity | % | 58 | 73 | 40 |

TABLE 2
Experimental data of the inventive and the non-inventive
pneumatic vehicle tires having the different rubber rim strips.

| Pneumatic vehicle tire | Name: | Multi2 | Single1 | Multi1 |
|---|---|---|---|---|
| | | Inv. | Non-inv. | Inv. |
| Rubber compounds | | | | |
| of the rubber rim strip | | | | |
| parts | | | | |
| Rubber compound of | 7a | E3 | E1 | E2 |
| the 1st rubber rim strip | | | | |
| part* | | | | |
| Rubber compound of | 7b | E1 | E1 | E1 |
| the 2nd rubber rim strip | | | | |
| part** | | | | |
| Tire properties | Unit | | | |
| Lateral stiffness | % | 125 | 100 | 100 |
| Rolling resistance | % | 98 | 100 | 103 |

*The first rubber rim strip part corresponds to the bead part of a vehicle tire, which is denoted by the reference sign 7a in the above list of reference signs and in FIG. 1.
**The second rubber rim strip part corresponds to the bead part of a vehicle tire, which is denoted by the reference sign 7a in the above list of reference signs and in FIG. 1.

In table 2, the advantages of a pneumatic vehicle tire according to the invention can best be seen. Depending on the requirements for a pneumatic vehicle tire according to the invention, it is possible for
1. its rolling resistance, by adjusting the Shore hardness of the rubber compound of the first rubber rim strip part (compare the columns Single1 and Multi2 in table 2), and/or
2. its lateral stiffness, by adjusting the rebound elasticity of the rubber compound of the first rubber rim strip part (compare the columns Single1 and Multi2 in table 2),
   to be improved.

Increasing the rebound elasticity of the rubber compound of the first rubber rim strip part therefore makes it possible to improve the desired rolling resistance of a pneumatic vehicle tire according to the invention (compare columns E1 and E2 in table 1). However, it is also possible to increase the lateral stiffness of a pneumatic vehicle tire according to the invention by increasing the Shore hardness of the rubber compound of the first rubber rim strip part (compare columns E1 and E3 in table 1). This makes it possible to exactly set both the rolling resistance and the lateral stiffness of a vehicle tire according to the invention. In particular, it is possible to produce pneumatic vehicle tires with increased lateral stiffness without impairing the rolling resistance (compare columns Single1 and Multi1 in table 2).

### LIST OF REFERENCE SIGNS

1 Rim of a vehicle wheel system according to the invention
1a Rim flange
1b Rim portion
2 Inner layer
3 Bead core
4 Carcass insert
4a Carcass turn-up
5 Sidewall
6 Core profile
7, 7′ Rubber rim strip in the respective bead region of the two bead regions of a pneumatic vehicle tire according to the invention
7a First rubber rim strip part made of first rubber compound
7b Second rubber rim strip part made of second rubber compound
8 Bead region of a pneumatic vehicle tire according to the invention of a vehicle wheel system according to the invention
9 Outer surface of the bead region
9a One part of the outer surface of the bead region
9b Other part of the outer surface of the bead region
10 Width of the first rubber rim strip part
11 Height of the first rubber rim strip part

1.-15. (canceled)

16. A pneumatic vehicle tire having a radial type construction, the tire comprising:
a bead region having a bead core;
a carcass insert running around the bead core and comprising a carcass turn-up extending in a direction of sidewalls;
a rubber rim strip that forms an outer surface of the bead region, the rubber rim strip comprising:
a first rubber rim strip consisting of a first rubber compound and runs along the carcass turn-up;
a second rubber rim strip consisting of a second rubber compound and is at least partially positioned between the bead core and a rim; and
the first rubber compound has a rebound resilience at 20° C. according to DIN 53512 in the range of 20% and 80% and the rebound resilience of the second rubber compound measured at 20° C. according to DIN 53512 differs from the rebound resilience of the first rubber compound.

17. The tire of claim 16, further comprising a second bead region having a second bead core and a second rubber rim strip that forms an outer surface of the second bead region, the second rubber rim strip comprising:
a first rubber rim strip consisting of the first rubber compound;
a second rubber rim strip consisting of the second rubber compound and is at least partially positioned between the bead core and a rim.

18. The tire of claim 16, wherein a ratio of a rebound resilience of the first rubber compound to a rebound resilience of the second rubber compound is in the range of 1:2 to 2:1.

19. The tire of claim 16, a ratio of a rebound resilience of the first rubber compound to a rebound resilience of the second rubber compound is in the range of 1.1:1 to 1.5:1.

20. The tire of claim 16, wherein the first rubber compound comprises one of a natural rubber and/or a butadiene rubber or consists of natural rubber and butadiene rubber, and/or the first and the second rubber compound comprises a natural rubber in amounts of 10 to 50 phr and/or a butadiene rubber in amounts of 50 to 90 phr.

21. The tire of claim 16, wherein the first and the second rubber compound comprise a filler present in an amount of 20 to 180 phr.

22. The tire of claim 16, wherein the first and the second rubber compound comprise a filler in an amount of 60 to 80 phr and the filler is carbon black.

23. The tire of claim 16, wherein the first and the second rubber compound comprise zinc oxide and stearic acid.

24. The tire of claim 23, the stearic acid is in the range of 5 to 9 phr.

25. The tire of claim 24, a total amount of zinc oxide and the stearic acid in the first rubber compound is in the range of 10 to 15 phr.

26. The tire of claim 16, wherein the first and the second rubber compound comprise sulfur and the total amount of sulfur in the second compound is in the range of 1 to 2.5 phr and the total amount of sulfur in the first rubber compound is in the range of 3 to 5 phr; and
the first and second rubber compounds comprise vulcanizing agents in addition to sulfer and in the range of 3 to 6 phr.

27. The tire of claim 16, wherein
the first rubber compound comprises a resin, wherein the resin is present in an amount of 1 to 9 phr,
and
the second rubber compound comprises a resin present in an amount of 0 to 4 phr.

28. The tire of claim 16, wherein
the first rubber compound has a Shore hardness in the range of 60 Sh A to 80 Sh A, measured at 20° C. by means of a durometer according to DIN ISO 7619-1;
and
the second rubber compound has a Shore hardness in the range of 65 Sh A to 80 Sh A, measured at 20° C. by means of a durometer according to DIN ISO 7619-1.

29. The tire of claim 16, wherein the ratio of the Shore hardness of the first rubber compound to the Shore hardness of the second rubber compound is in the range of 1:2 to 4:1, preferably in the range of 1:1.5 to 2:1, particularly preferably in the range of 1:1.1 to 1.5:1, more particularly preferably in the range of 1:1.1 to 1.1:1, in each case measured at 20° C. by means of a durometer according to DIN ISO 7619-1.

30. The tire of claim 16, wherein
the first rubber compound has a rebound elasticity of greater than 50%, preferably in the range of above 50% to 90%, particularly preferably in the range of above 65% to 80%, measured at 20° C. according to DIN 53512,
and
the second rubber compound has a rebound elasticity of less than 80%, preferably in the range of 20% to 64%, preferably in the range of 55% to 64%, in each case measured at 20° C. according to DIN 53512.

31. The tire of claim 16, wherein a ratio of a width of the first rubber rim strip part to a height of the first rubber rim strip part is in the range of 1:3 to 1:7, and
a ratio of the height of the first rubber rim strip part to a nominal height of the tire is in the range of 1:3 to 1:7.

32. The tire of claim 17, the rubber resilience of the first rubber compound is configured to provide a selected rolling resistance of the tire independent of the rubber resilience of the second compound.

33. The tire of claim 32, the rubber resilience of the second compound is configured to provide a selected lateral stiffness of the tire independent of the rubber resilience of the first compound.
